(19) United States
(12) Patent Application Publication
(10) Pub. No.: US 2024/0028776 A1
(43) Pub. Date: Jan. 25, 2024

(54) INPUT/OUTPUT (I/O) ATTACK PREVENTION SYSTEM AND METHOD OF USING THE SAME

(71) Applicant: Dell Products, L.P., Round Rock, TX (US)

(72) Inventors: Mahesh Babu Ramaiah, Bangalore (IN); Ajay Shenoy, Bangalore (IN); Michael Emery Brown, Austin, TX (US)

(73) Assignee: Dell Products, L.P., Round Rock, TX (US)

(21) Appl. No.: 17/814,635

(22) Filed: Jul. 25, 2022

(51) Int. Cl. G06F 21/83; G06F 21/84

(52) U.S. Cl. CPC G06F 21/83; G06F 21/84

(57) ABSTRACT

Embodiments of the present disclosure provide a system and method for providing an input/output (I/O) attack prevention system and method for an Information Handling System (IHS) that is managed by a systems management console. One embodiment of the I/O device attack prevention system includes a systems manager in communication with multiple server IHSs configured in a data center. The IHS includes executable instructions to detect that an I/O device has been connected to an external I/O port of the IHS, and send information associated with the I/O device detection to the systems manager such that it determines whether the I/O device is authorized for use with the IHS. The IHS receives the results of the determination from the systems manager, and allows or disallows use of the I/O device with the IHS based on the results of the determination.

### BACKGROUND

As the value and use of information continues to increase, individuals and businesses seek additional ways to process and store information. One option is an Information Handling System (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware, and software components that may be configured to process, store, and communicate information and may include one or more computer systems, data storage systems, and networking systems.

Modern day computing resources are provided by large computing environments that may include server farms, computer clusters, individual computing devices, and/or data centers. Computing environments are generally associated with large organizations, such as business enterprises to educational institutions such as universities. In many cases, larger organizations may manage multiple server farms over a diverse geographical region. Nevertheless, management of such large, diversified computing environments are typically provided by remotely configured system management consoles. OpenManage Enterprise is one example of a system management console provided by Dell Technologies, which cost-effectively facilitates comprehensive lifecycle management for the computing devices of distributed computing environments from one console.

### SUMMARY

Embodiments of the present disclosure provide a system and method for providing an input/output (I/O) attack prevention system and method for an Information Handling System (IHS) that is managed by a systems management console. One embodiment of the I/O device attack prevention system includes a systems manager in communication with multiple server IHSs configured in a data center. The IHS includes executable instructions to detect that an I/O device has been connected to an external I/O port of the IHS, and send information associated with the I/O device detection to the systems manager such that it determines whether the I/O device is authorized for use with the IHS. The IHS receives the results of the determination from the systems manager, and allows or disallows use of the I/O device with the IHS based on the results of the determination.

According to another embodiment an I/O device attack prevention method includes the steps of detecting that an I/O device has been connected to an external I/O port of the Information Handling Systems (IHS), sending, to a systems manager that manages the operation of the IHS, information associated with the I/O device detection in which the systems manager is configured to determine whether the I/O device is authorized for use with the HIS. The method also includes the steps of receiving the results of the determination from the systems manager, and allowing or disallowing use of the I/O device with the IHS based on the results of the determination.

According to yet another embodiment, a computer program product includes computer-executable program instructions to detect that an I/O device has been connected to an external I/O port of the HIS, and send, to the systems manager, information associated with the I/O device detection, wherein the systems manager is configured to determine whether the I/O device is authorized for use with the IHS. The program instructions also receive the results of the determination from the systems manager, and allow or disallow use of the I/O device with the IHS based on the results of the determination.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 illustrates an example I/O device attack prevention system according to one embodiment of the present disclosure.

FIG. 2 is a block diagram illustrating several examples components of an Information Handling System (IHS) that may be used to implement a I/O device attack prevention system and method according to one embodiment of the present disclosure.

FIG. 3 is a diagram view illustrating several components of the example I/O device attack prevention system according to one embodiment of the present disclosure.

FIG. 4 is a workflow diagram describing certain steps that may be performed by a I/O device attack prevention method using the systems manager according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Embodiments of the present disclosure provide an input/output (I/O) device attack prevention system and method that ensures I/O devices are authorized for use before allowing those I/O devices to be used with an Information Handling System (IHS). Whereas the use of I/O devices, such as Universal Serial Bus (USB) devices, are typically not allowed in computing environments due to the ease of injecting USB based attacks, beneficial operations that could otherwise be performed using the I/O devices are inhibited. Embodiments of the present disclosure provide a solution to this problem using an I/O device attack prevention system that detects when an I/O device has been connected to an external I/O port of the IHS, and sends information associated with the I/O device detection to a systems manager that manages the operation of the IHS. The systems manager determines whether the I/O device is authorized for use with the IHS, and sends the results of the determination to the IHS. When the IHS receives the results of the determination from the systems manager, it can then allow or disallow use of the I/O device with the IHS based on the results of the determination.

Information handling systems often use external I/O ports, such as USB ports, to allow for external coupling of various components to the information handling system, including mass storage devices (e.g., flash drives), human interface devices (e.g., keyboard/video/mouse devices), network interfaces, or other devices. A disadvantage of such external ports, however, is that they may expose security vulnerabilities as individuals acting as bad actors may use external devices to perpetrate attacks through external ports, or surreptitiously place malware on an external device such that an authorized but unaware user may unknowingly couple such external device to an external port, thus compromising the IHS. Conventionally, such vulnerabilities were reduced by disabling external ports, only to have an administrator enable such ports if and when needed. However, in such traditional approaches, IHSs have only allowed for a boot time only basic input/output system (BIOS) menu option to disable various combinations of server USB ports (e.g., all external, all front, all rear, internal, etc.).

Security researchers have identified several diverse types of USB attacks. USB devices are therefore not allowed/recommended within large computing environments, such as data centers because of the ease of injecting USB based attacks. Detection of malicious USB devices, prevention of USB attacks, recovery of USB devices to a safe state are persistent problems to users (e.g., IT administrators) of computing environments.

Management of a large, diversified data center is typically provided by a remotely configured system management console. Openmanage Enterprise is one example of a system management console provided by Dell Technologies, which cost-effectively facilitates comprehensive lifecycle management for the computing devices of distributed computing environments (e.g., data center) from one console. While such systems management consoles have been an effective tool for remotely managing IHSs, they have not heretofore been used to facilitate safe usage of I/O devices of the IHSs that they manage. For example, a computing environment that is configured to provide computing resources for each of a number of employees of a corporation still relies upon static I/O device policies with regard to secure use of I/O devices by the employees. This technique, nevertheless, does not account for ongoing changes to security threats that may be caused by illicitly configured I/O devices.

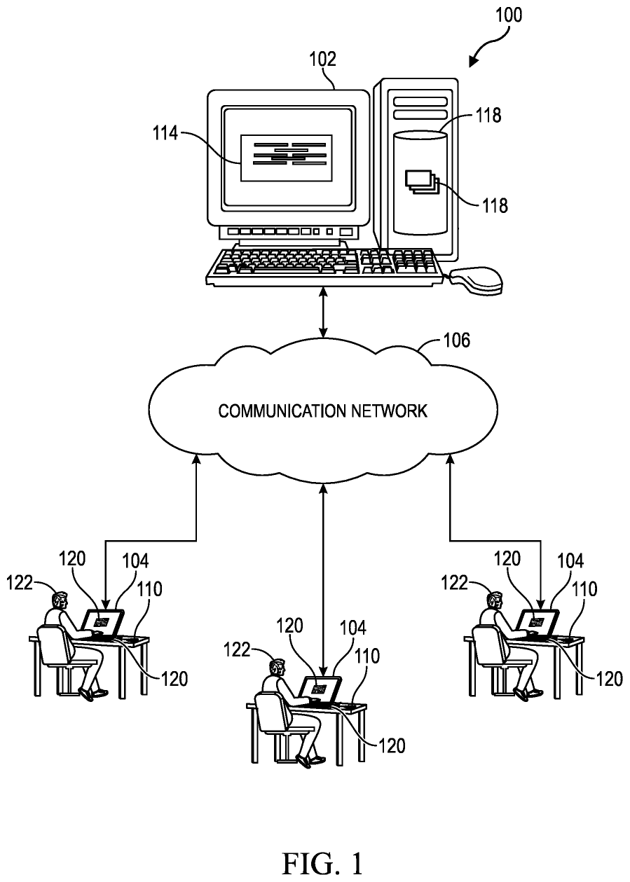

FIG. 1 illustrates an example I/O device attack prevention system 100 according to one embodiment of the present disclosure that may provide a solution to these problems, among others. The I/O device attack prevention 100 includes a system management appliance 102 that communicates with the IHSs 104 configured in a computing environment. As shown, the system management appliance 102 communicates with the IHSs 104 through a communication network 106, such as the Internet. Nevertheless, it should be appreciated that the system management appliance 102 may communicate locally with the IHSs 104. The system management appliance 102 may be any type that is administered by an organization, such as a corporation, school, or other enterprise that may supply IHSs 104 to some, most, or all of its members or customers. In one embodiment, the system management appliance 102 may be, for example, one managed by a vendor of the IHSs 104.

According to embodiments of the present disclosure, executable instructions in each of the IHSs 104 continually monitors each of the IHSs 104 for an I/O device insertion event caused by an I/O device 110 that is inserted into a port 112 of the IHS 104. When such an event occurs, executable instructions in the IHS 104 temporarily inhibits the I/O device 110 from being used with (e.g., attached to) the IHS 104. Within this disclosure, the act of the I/O device 110 being used by the IHS 104 refers to a condition in which the features of the I/O device 110 may be actively accessed and utilized by the IHS 104. In a particular case in which the I/O device 110 comprises a flash memory (e.g., memory stick, flash drive, USB stick, etc.), the I/O device 110 is being used when the memory contents of the flash memory are accessible by the IHS 104, such as, for example, by a file browser executed on the IHS 104.

In general, when executable instructions in one of the IHSs 104 detects the insertion, it also sends information associated with the inserted I/O device 110 to the system management appliance 102. The system management appliance 102 may then determine whether the I/O device 110 is authorized for use with the IHS 104. In one embodiment, the system management appliance 102 may generate a pop-up window 114 or other suitable notification mechanism whereby it can receive user input for determining whether the I/O device 110 is authorized. In another embodiment, the system management appliance 102 may access one or more port security policies 116 stored in a database 118 to determine whether the I/O device 110 is authorized. For example, the system management appliance 102 may access the port security policies 116 to determine whether the I/O device 110 meets certain whitelisting or blocklisting criteria. If no whitelisting or blocklisting criteria are met, the system management appliance 102 may generate a pop-up window 114 to receive user input for determining whether the I/O device 110 is authorized or not. The system management appliance 102 then sends the results of the determination to the IHS 104.

When the IHS 104 receives the results of the determination, it either allows or disallows use of the I/O device 110 based on the determination made by the system management appliance 102. In one embodiment, the executable instructions in the IHS 104 may generate a pop-up window 120 informing the user 122 that use of the I/O device 110 is halted pending approval by the system management appliance 102. Additionally, if approval for use of the I/O device 110 is denied, the instructions may generate another pop-up window or the same pop-up window 120 informing the user 122 that the I/O device 110 has been denied for use with the IHS 104. The features of the system 100 may function with any suitable type of computing environment. For example, the computing environment may be a server farm, a computer cluster, an individual computing device, and/or a data center. In one embodiment, the instructions may also store information with the results of the determination in a logfile on a secure memory portion of the IHS 104 as will be described in detail herein below.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory.

Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, touchscreen and/or a video display. The IHS may also include one or more buses operable to transmit communications between the various hardware components.

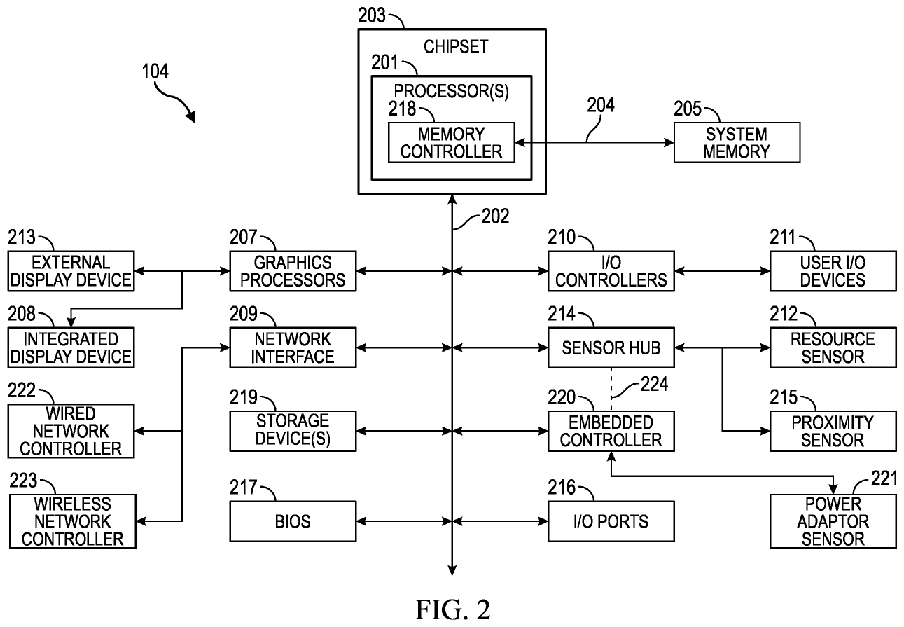

FIG. 2 is a block diagram illustrating components of an example IHS 104 according to one embodiment of the present disclosure. IHS 104 may be incorporated in whole, or part, as IHS 104 of FIG. 1. As shown, IHS 104 includes one or more processors 201, such as a Central Processing Unit (CPU), that execute code retrieved from system memory 205. Although IHS 104 is illustrated with a single processor 201, other embodiments may include two or more processors, that may each be configured identically, or to provide specialized processing operations. Processor 201 may include any processor capable of executing program instructions, such as an Intel Pentium™ series processor or any general-purpose or embedded processors implementing any of a variety of Instruction Set Architectures (ISAs), such as the x86, POWERPC®, ARM®, SPARC®, or MIPS® ISAs, or any other suitable ISA.

In the embodiment of FIG. 2, processor 201 includes an integrated memory controller 218 that may be implemented directly within the circuitry of processor 201, or memory controller 218 may be a separate integrated circuit that is located on the same die as processor 201. Memory controller 218 may be configured to manage the transfer of data to and from the system memory 205 of IHS 104 via high-speed memory interface 204. System memory 205 that is coupled to processor 201 provides processor 201 with a high-speed memory that may be used in the execution of computer program instructions by processor 201.

Accordingly, system memory 205 may include memory components, such as static RAM (SRAM), dynamic RAM (DRAM), NAND Flash memory, suitable for supporting high-speed memory operations by the processor 201. In certain embodiments, system memory 205 may combine both persistent, non-volatile memory and volatile memory. In certain embodiments, system memory 205 may include multiple removable memory modules.

IHS 104 utilizes chipset 203 that may include one or more integrated circuits that are connected to processor 201. In the embodiment of FIG. 2, processor 201 is depicted as a component of chipset 203. In other embodiments, all of chipset 203, or portions of chipset 203 may be implemented directly within the integrated circuitry of the processor 201. Chipset 203 provides processor(s) 201 with access to a variety of resources accessible via bus 202. In IHS 104, bus 202 is illustrated as a single element. Various embodiments may utilize any number of separate buses to provide the illustrated pathways served by bus 202.

In various embodiments, IHS 104 may include one or more I/O ports 216 that may support removable couplings with diverse types of external devices and systems, including removable couplings with peripheral devices that may be configured for operation by a particular user of IHS 104. For instance, I/O 216 ports may include USB (Universal Serial Bus) ports, by which a variety of external devices may be coupled to IHS 104. In addition to or instead of USB ports, I/O ports 216 may include diverse types of physical I/O ports that are accessible to a user via the enclosure of the IHS 104.

In certain embodiments, chipset 203 may additionally utilize one or more I/O controllers 210 that may each support the operation of hardware components such as user I/O devices 211 that may include peripheral components that are physically coupled to I/O port 216 and/or peripheral components that are wirelessly coupled to IHS 104 via network interface 209. In various implementations, I/O controller 210 may support the operation of one or more user I/O devices 211 such as a keyboard, mouse, touchpad, touchscreen, microphone, speakers, camera and other input and output devices that may be coupled to IHS 104. User I/O devices 211 may interface with an I/O controller 210 through wired or wireless couplings supported by IHS 104. In some cases, I/O controllers 210 may support configurable operation of supported peripheral devices, such as user I/O devices 211.

As illustrated, a variety of additional resources may be coupled to the processor(s) 201 of the IHS 104 through the chipset 203. For instance, chipset 203 may be coupled to network interface 209 that may support distinct types of network connectivity. IHS 104 may also include one or more Network Interface Controllers (NICs) 222 and 223, each of which may implement the hardware required for communicating via a specific networking technology, such as Wi-Fi, BLUETOOTH, Ethernet and mobile cellular networks (e.g., CDMA, TDMA, LTE). Network interface 209 may support network connections by wired network controllers 222 and wireless network controllers 223. Each network controller 222 and 223 may be coupled via various buses to chipset 203 to support distinct types of network connectivity, such as the network connectivity utilized by IHS 104.

Chipset 203 may also provide access to one or more display device(s) 208 and 213 via graphics processor 207. Graphics processor 207 may be included within a video card, graphics card or within an embedded controller installed within IHS 104. Additionally, or alternatively, graphics processor 207 may be integrated within processor 201, such as a component of a system-on-chip (SoC). Graphics processor 207 may generate Display information and provide the generated information to one or more Display device(s) 208 and 213, coupled to IHS 104.

One or more Display devices 208 and 213 coupled to IHS 104 may utilize LCD, LED, OLED, or other Display technologies. Each Display device 208 and 213 may be capable of receiving touch inputs such as via a touch controller that may be an embedded component of the Display device 208 and 213 or graphics processor 207, or it may be a separate component of IHS 104 accessed via bus 202. In some cases, power to graphics processor 207, integrated Display device 208 and/or external Display device 213 may be turned off, or configured to operate at minimal power levels, in response to IHS 104 entering a low-power state (e.g., standby).

As illustrated, IHS 104 may support an integrated Display device 208, such as a Display integrated into a laptop, tablet, 2-in-1 convertible device, or mobile device. IHS 104 may also support use of one or more external Display devices 213, such as external monitors that may be coupled to IHS 104 via distinct types of couplings, such as by connecting a cable from the external Display devices 213 to external I/O port 216 of the IHS 104. In certain scenarios, the operation of integrated displays 208 and external displays 213 may be configured for a particular user. For instance, a particular user may prefer specific brightness settings that may vary the Display brightness based on time of day and ambient lighting conditions.

Chipset 203 also provides processor 201 with access to one or more storage devices 219. In various embodiments, storage device 219 may be integral to IHS 104 or may be external to IHS 104. In certain embodiments, storage device 219 may be accessed via a storage controller that may be an integrated component of the storage device. Storage device 219 may be implemented using any memory technology allowing IHS 104 to store and retrieve data. For instance, storage device 219 may be a magnetic hard disk storage drive or a solid-state storage drive. In certain embodiments, storage device 219 may be a system of storage devices, such as a cloud system or enterprise data management system that is accessible via network interface 209.

As illustrated, IHS 104 also includes Basic Input/Output System (BIOS) 217 that may be stored in a non-volatile memory accessible by chipset 203 via bus 202. Upon powering or restarting IHS 104, processor(s) 201 may utilize BIOS 217 instructions to initialize and test hardware components coupled to the IHS 104. BIOS 217 instructions may also load an operating system (OS) (e.g., WINDOWS, MACOS, iOS, ANDROID, LINUX, etc.) for use by IHS 104.

BIOS 217 provides an abstraction layer that allows the operating system to interface with the hardware components of the IHS 104. The Unified Extensible Firmware Interface (UEFI) was designed as a successor to BIOS. As a result, many modern IHSs utilize UEFI in addition to or instead of a BIOS. As used herein, BIOS is intended to also encompass UEFI.

As illustrated, certain IHS 104 embodiments may utilize sensor hub 214 capable of sampling and/or collecting data from a variety of sensors. For instance, sensor hub 214 may utilize hardware resource sensor(s) 212, which may include electrical current or voltage sensors, and that are capable of determining the power consumption of various components of IHS 104 (e.g., CPU 201, GPU 207, system memory 205, etc.). In certain embodiments, sensor hub 214 may also include capabilities for determining a location and movement of IHS 104 based on triangulation of network signal information and/or based on information accessible via the OS or a location subsystem, such as a GPS module.

In some embodiments, sensor hub 214 may support proximity sensor(s) 215, including optical, infrared, and/or sonar sensors, which may be configured to provide an indication of a user's presence near IHS 104, absence from IHS 104, and/or distance from IHS 104 (e.g., near-field, mid-field, or far-field).

In certain embodiments, sensor hub 214 may be an independent microcontroller or other logic unit that is coupled to the motherboard of IHS 104. Sensor hub 214 may be a component of an integrated system-on-chip incorporated into processor 201, and it may communicate with chipset 203 via a bus connection such as an Inter-Integrated Circuit (I²C) bus or other suitable type of bus connection. Sensor hub 214 may also utilize an I²C bus for communicating with various sensors supported by IHS 104.

As illustrated, IHS 104 may utilize embedded controller (EC) 220, which may be a motherboard component of IHS 104 and may include one or more logic units. In certain embodiments, EC 220 may operate from a separate power plane from the main processors 201 and thus the OS operations of IHS 104. Firmware instructions utilized by EC 220 may be used to operate a secure execution system that may include operations for providing various core functions of IHS 104, such as power management, management of operating modes in which IHS 104 may be physically configured and support for certain integrated I/O functions.

EC 220 may also implement operations for interfacing with power adapter sensor 221 in managing power for IHS 104. These operations may be utilized to determine the power status of IHS 104, such as whether IHS 104 is operating from battery power or is plugged into an AC power source (e.g., whether the IHS is operating in AC-only mode, DC-only mode, or AC+DC mode). In some embodiments, EC 220 and sensor hub 214 may communicate via an out-of-band signaling pathway or bus 224.

In various embodiments, IHS 104 may not include each of the components shown in FIG. 2. Additionally, or alternatively, IHS 104 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor(s) 201 as an SoC.

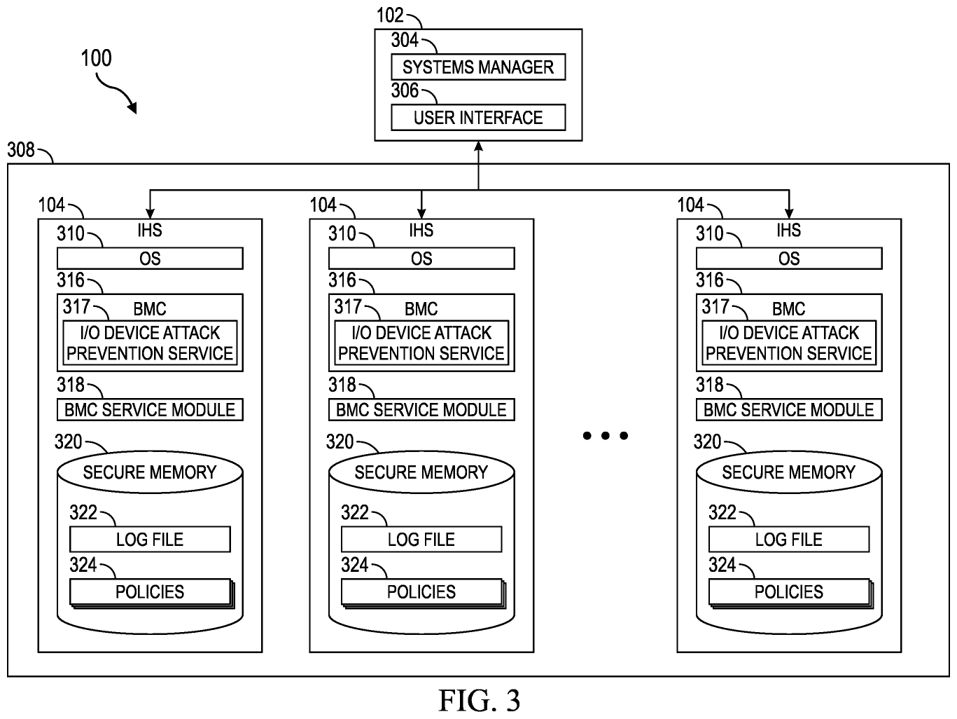

FIG. 3 is a diagram view illustrating several components of the example I/O device attack prevention system 100 according to one embodiment of the present disclosure. The I/O device attack prevention system 100 includes a systems management appliance 102 installed with a systems manager 304 and a user interface 306 that is in communication with the IHSs 104 of a computing environment 308. In one embodiment, the user interface 306 provides at least a portion of the features of a systems management console. For the purposes of this disclosure, the term “system management console” may refer broadly to systems that are configured to couple to a management controller and issue management instructions for an information handling system (e.g., computing device) that is being managed by the management controller. One example of such a system management console is the Dell OpenManage Enterprise (OME) systems management console.

In various embodiments, management consoles may be implemented via specialized hardware and/or via software running on a standard information handling system. In one embodiment, a system management console may be deployed on a secure virtual machine (VM), such as a VMWARE Workstation appliance. For example, the user interface 306 may be comprised of at least a portion of a web browser. Additionally, the user interface 306 may be executed by the same systems management appliance 102 that is used to run the systems manager 304, or by another remotely configured IHS.

The systems manager 304 monitors and controls the operation of various components of the IHS 104 as described above with reference to FIG. 2. In one embodiment, systems manager 304 includes at least a portion of the Dell EMC OpenManage Enterprise (OME) that is installed on a secure virtual machine (VM), such as a VMWARE Workstation. In another embodiment, the systems manager 304 includes at least a portion of the Dell EMC OpenManage Mobile (OMM) app that is installed on a cellular smartphone.

The IHSs 104 of the computing environment 308 are each configured with an Operating System (OS) 310, a Baseboard Management Controller (BMC) 316, a BMC service module 318, and a secure memory 320, that stores a logfile 322 and one or more local port security policies 324. The logfile 322 includes information, among other things, about events managed by the BMC 316. The BMC 316 is used to monitor, and in some cases manage computer hardware components of their respective IHS 104. For example, the BMC 316 may allow information technology (IT) administrators to deploy, update, monitor, and maintain IHSs 104 remotely. As a non-limiting example of a remote access controller, the integrated Dell Remote Access Controller (iDRAC) from Dell is embedded within Dell PowerEdge™ servers and provides such remote functionality. The BMC 316 may manage operation of the OS 310 on which various applications execute. One application may include, for example, a BMC service module 318 that is suitable to interface with BMC 316 for controlling the operating of the OS 310. As a non-limiting example, a BMC service module 318 may include an iDRAC service module (iSM) from Dell Technologies.

According to embodiments of the present disclosure, the BMC 316 is configured with a I/O device attack prevention service 317 that ensures I/O devices 110 are authorized before they are allowed for use on their respective IHSs 104. When an I/O device 110 is inserted, the I/O device attack prevention service 317 begins to obtain information (e.g., enumerate) about the I/O device 110. For example, the I/O device attack prevention service 317 may obtain information such as storage capacity, existing files stored in the I/O device 110, file format (e.g., ext3, ext4, fat32, ntfs, etc.), I/O device interface type (e.g., USB2, USB3, USB3.1, etc.), and device type (e.g., mouse, keyboard, flash memory, camera, etc.), which may be subsequently sent to the system management appliance 102. In one embodiment, the I/O device attack prevention service 317 controls the OS 310 to only load the respective USB driver for the I/O device 110 after the device has been authorized. In this manner, the I/O device 110 may be temporarily inhibited from being used with the IHS 104 until it has been authorized. For cases, in which the authorization is denied, use of the I/O device 110 with the IHS 104 may be inhibited permanently.

In one embodiment, the I/O device attack prevention service 317 may communicate with the BMC service module 318 to log the insertion event and whether the I/O device 110 was authorized or not. In another embodiment, the system 100 may utilize a Machine Learning (ML) process (not shown) to infer trends in illicit I/O device usage over time. These inferred trends may be analyzed by personnel to determine certain actions that may be taken in the future to thwart future security exploits that may be committed by illicit I/O devices 110. The ML process may be executed by each or certain IHSs 104 to obtain trends in its respective IHS 104, or alternatively, the ML process may be executed by the system management appliance 102 to identify trends that may occur over the computing environment 308.

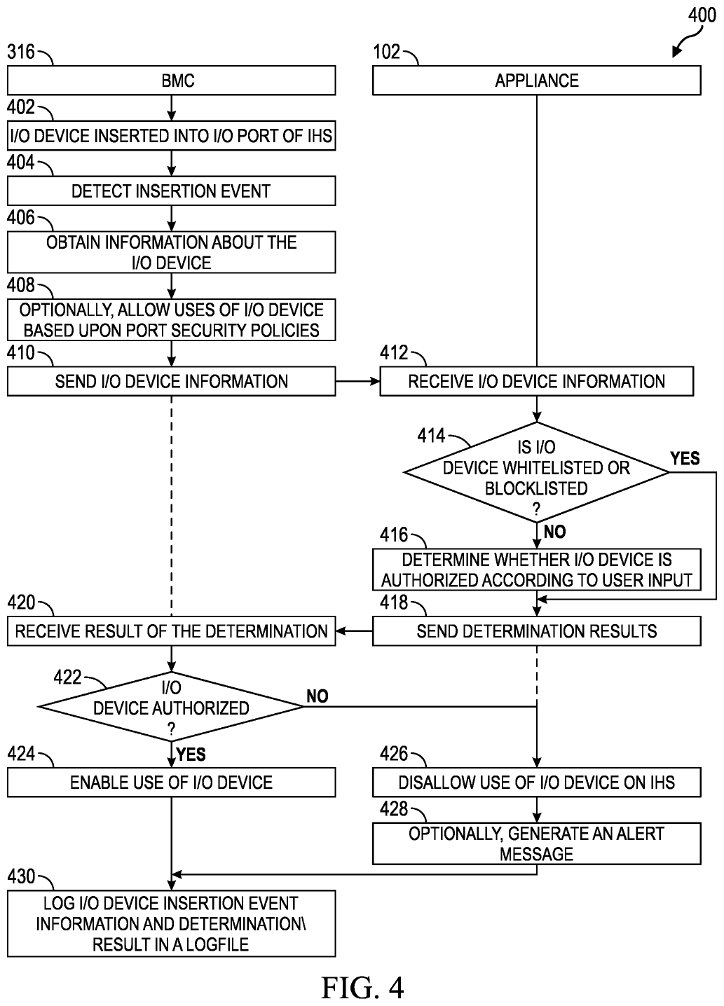

FIG. 4 is a workflow diagram describing certain steps that may be performed by a I/O device attack prevention method 400 using the systems manager 304 according to one embodiment of the present disclosure. Additionally or alternatively, the method 400 may be performed at least in part, using the BMC 316 of an IHS 104, and the system management appliance 102 as described herein above. Initially, the systems manager 304 and the IHS 104 have been started and are operating in a normal manner.

At step 402, an I/O device is inserted into an I/O port of an IHS 104, and at step 404, the BMC 316 detects the insertion event. At this point, the OS 310 is configured to only load an I/O driver associated with the I/O device 110 upon explicit request from BMC 316. Thus, because the BMC 316 does not provide the request to the OS 310 at this time, I/O device 110 is temporarily inhibited from use.

At step 406, the BMC 316 obtains information about the I/O device 110. For example, the BMC 316 may obtain a storage capacity, any existing files, a file format, I/O device interface type, and device type, among other information from the I/O device 110. At step 408, the BMC 316 may optionally allow use of the I/O device 110 based upon one or more port security policies. For example, the port security policies may include certain criteria that if met by the I/O device 110, cause the BMC 316 to determine, without the assistance of the system management appliance 102, that the I/O device 110 should be authorized for use with the IHS 104. That is, the I/O device 110 may be whitelisted based upon certain whitelisting port security policies. Conversely, the port security policies may include certain criteria that if met by the I/O device 110, cause the BMC 316 to determine, without the assistance of the system management appliance 102, that the I/O device 110 should be disallowed from use with the IHS 104. That is, the I/O device 110 may be blocklisted based upon certain blocklisting port security policies. One example of such an I/O port screening system may include an external I/O port screening system and method as disclosed in U.S. Pat. No. 10,146,963, which is entitled “Systems and Methods for Dynamic External I/O Port Screening,” and filed on Aug. 4, 2016, the contents of which are incorporated by reference in its entirety. At step 410, when the BMC 316 has gathered the information about the I/O device 110, it then sends the I/O device information to the system management appliance 102.

The system management appliance 102 receives the I/O device information from the BMC 316 at step 412, and determines whether the I/O device 110 is whitelisted or blocklisted at step 414. For example, the system management appliance 102 may include executable instructions that are at least somewhat similar to that described above with reference to step 408 in which the console may access one or more port security policies 116 stored in the system management appliance 102 to determine whether that I/O device 110 should be whitelisted or blocklisted. It should be appreciated that step 414 is optional and may be performed in lieu of step 408, or in addition to step 408. Nevertheless, if the I/O device 110 possesses at least one criterion matching a whitelisted/blocklisted port security policy 116, processing continues at step 418; otherwise, processing continues at step 416 in which the system management appliance 102 determines whether the I/O device 110 is authorized according to user input. That is, the system management appliance 102 may generate a pop-up window that queries the user (IT Administrator) whether to allow or disallow the I/O device 110. Thereafter at step 418, the system management appliance 102 sends the determination results to the BMC 316.

The BMC 316 at step 420 receives the results of the determination and identifies whether the I/O device 110 has been authorized or not at step 422. If the I/O device 110 is authorized, processing continues at step 424 in which use of the I/O device 110 is enabled. In one example, the BMC 316 may issue a request to the OS 310 to load the I/O driver associated with the I/O device 110, which in turn, communicates with a I/O port controller of the I/O port 112 so that the I/O device 110 can be used with the IHS 104.

At step 426, the BMC 316 disallows use of the I/O device 110. For example, the BMC 316 may disallow use of the I/O device 110 by not sending the request to load the I/O driver associated with the I/O device to the OS 310. Thereafter at step 428, the BMC 316 may generate an alert message that includes information about the failed attempted use of the I/O device 110 by the user 122. For example, the alert message may be a pop-up window 120 displayed on a display of the IHS 104 informing the user 122 that the I/O device 110 has been rejected by the system. At step 430, the BMC 316 may also log the I/O device insertion event information and determination results in a logfile for future reference, such as in the logfile 322 of the BMC service module 318.

The method 400 described above may be repeated each time an I/O device 110 is inserted into an I/O device port 112 of the IHS 104. Nevertheless, at this point the method 400 ends.

Although FIG. 4 describes an example method 400 that may be performed for providing I/O device attack prevention method, the features of the method 400 may be embodied in other specific forms without deviating from the spirit and scope of the present disclosure. For example, the method 400 may perform additional, fewer, or different operations than those described in the present examples. As another example, the steps of the aforedescribed method 400 may be performed in a sequence other than what is described above. As yet another example, certain steps of the aforedescribed process may be performed by components other than the BMC 316 and/or system management appliance 102 without departing from the spirit and scope of the present disclosure.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

What is claimed is:

1. An I/O device attack prevention system comprising:
an Information Handling System (IHS) in communication with a systems manager, the IHS comprising instructions stored in a memory that, upon execution by at least one processor, cause the processor to:
detect that an I/O device has been connected to an external I/O port of the IHS;
send, to the systems manager, information associated with the I/O device detection, wherein the systems manager is configured to determine whether the I/O device is authorized for use with the IHS;
receive the results of the determination from the systems manager; and
allow or disallow use of the I/O device with the IHS based on the results of the determination.

2. The I/O device attack prevention system of claim 1, wherein the instructions are performed by a Baseboard Management Controller (BMC) configured inside the IHS.

3. The I/O device attack prevention system of claim 1, wherein the IHS comprises one of a plurality of IHSS managed by the systems manager.

4. The I/O device attack prevention system of claim 3, wherein the systems manager communicates with the IHSS through a communication network.

5. The I/O device attack prevention system of claim 1, wherein the instructions, upon execution, further cause the processor to whitelist or blocklist the I/O device based on one or more port security policies, and determine whether the I/O device is authorized for use based the whitelisting or blocklisting of the I/O device.

6. The I/O device attack prevention system of claim 1, wherein the systems manager is configured to whitelist or blocklist the I/O device based on one or more port security policies, and determine whether the I/O device is authorized for use based the whitelisting or blacklisting of the I/O device.

7. The I/O device attack prevention system of claim 1, wherein the instructions, upon execution, further cause the processor to generate a notification for a user of the IHS that the I/O device is waiting for authorization.

8. The I/O device attack prevention system of claim 1, wherein the instructions, upon execution, further cause the processor to log information associated with the I/O device detection and whether the I/O device has been authorized for use with the IHS.

9. The I/O device attack prevention system of claim 1, wherein the external I/O port comprises a Universal Serial Bus (USB) port and the I/O device comprises a USB device.

10. The I/O device attack prevention system of claim 1, wherein the systems manager is configured to generate a query message to receive user input for determining whether to authorize the I/O device for use with the IHS.

11. An I/O device attack prevention method comprising:
detecting that an I/O device has been connected to an external I/O port of the Information Handling Systems (IHS);
sending, to a systems manager that manages the operation of the IHS, information associated with the I/O device detection, wherein the systems manager is configured to determine whether the I/O device is authorized for use with the IHS;
receiving the results of the determination from the systems manager; and
allowing or disallowing use of the I/O device with the IHS based on the results of the determination.

12. The I/O device attack prevention method of claim 11, further comprising performing the instructions by a Baseboard Management Controller (BMC) configured inside the IHS.

13. The I/O device attack prevention method of claim 11, further comprising wherein the systems manager communicates with the IHSS through a communication network, wherein the IHS comprises one of a plurality of IHSS managed by the systems manager.

14. The I/O device attack prevention method of claim 11, further comprising whitelisting or blocklisting the I/O device based on one or more port security policies, and determining whether the I/O device is authorized for use based the whitelisting or blocklisting of the I/O device.

15. The I/O device attack prevention method of claim 11, further comprising whitelisting or blacklisting, by the systems manager, the I/O device based on one or more port security policies, and determine whether the I/O device is authorized for use based the whitelisting or blacklisting of the I/O device.

16. The I/O device attack prevention method of claim 11, further comprising generating a notification for a user of the IHS that the I/O device is waiting for authorization.

17. The I/O device attack prevention method of claim 11, further comprising logging information associated with the I/O device detection and whether the I/O device has been authorized for use with the IHS.

18. The I/O device attack prevention method of claim 11, further comprising generating, by the systems manager, a query message to receive user input for determining whether to authorize the I/O device for use with the IHS.

19. A computer program product comprising a computer readable storage medium having program instructions embodied therewith, the program instructions executable by a processor to cause the processor to perform the following:
detect that an I/O device has been connected to an external I/O port of the IHS;
send, to the systems manager, information associated with the I/O device detection, wherein the systems manager is configured to determine whether the I/O device is authorized for use with the IHS;
receive the results of the determination from the systems manager; and
allow or disallow use of the I/O device with the IHS based on the results of the determination.

20. The computer program product of claim 19, wherein the IHS comprises one of a plurality of IHSs managed by the systems manager, and wherein the systems manager communicates with the IHSS through a communication network.
